(19) United States
(12) Patent Application Publication
(10) Pub. No.: US 2024/0207736 A1
(43) Pub. Date: Jun. 27, 2024

(54) GAME PROCESS CONTROL METHOD AND APPARATUS, ELECTRONIC DEVICE, AND STORAGE MEDIUM

(71) Applicant: NETEASE (HANGZHOU) NETWORK CO., LTD., Hangzhou, Zhejiang (CN)

(72) Inventors: Guang LI, Hangzhou, Zhejiang (CN); Chao LIU, Hangzhou, Zhejiang (CN); Xiangyu WANG, Hangzhou, Zhejiang (CN)

(73) Assignee: NETEASE (HANGZHOU) NETWORK CO., LTD., Hangzhou, Zhejiang (CN)

(21) Appl. No.: 18/556,110

(22) PCT Filed: Feb. 24, 2022
(86) PCT No.: PCT/CN2022/077599

§ 371 Date: Oct. 19, 2023

(30) Foreign Application Priority Data
Apr. 19, 2021 (CN) 202110421216.5

(51) Int. Cl. A63F 13/45; A63F 13/52; A63F 13/5378; A63F 13/55; A63F 13/69; A63F 13/822

(52) U.S. Cl. CPC A63F 13/45; A63F 13/52; A63F 13/5378; A63F 13/55; A63F 13/69; A63F 13/822

(57) ABSTRACT

The present disclosure provides a method for controlling a game progress, including: displaying, in the action stage, at least part of a first virtual scene of the action stage and a first virtual object located in the first virtual scene; obtaining a skill configuration parameter of the first virtual object to determine an additional skill, newly added on a basis of a character default skill, of the first virtual object; when determining that a completion progress of a virtual task in the game stage reaches a progress threshold, controlling the first virtual object to unlock the additional skill, and providing an additional skill control on a basis of providing a default skill control in the graphical user interface; and controlling the graphical user interface to display a second virtual scene corresponding to the discussion stage in response to a preset trigger event.

### CROSS REFERENCE TO RELATED APPLICATIONS

The present application is the U.S. National Phase application of PCT Application No. PCT/CN2022/077599, filed on Feb. 24, 2022, which is based upon and claims the priority to the Chinese Patent Application NO. 202110421216.5, entitled “METHOD AND APPARATUS FOR CONTROLLING GAME PROGRESS, ELECTRONIC DEVICE, AND STORAGE MEDIUM”, filed on Apr. 19, 2021, the entire content of both of which is hereby incorporated by reference.

### TECHNICAL FIELD

The present disclosure relates to the field of game technologies, and in particular, to a method and apparatus for controlling a game progress, an electronic device, and a storage medium.

### BACKGROUND

At present, reasoning games that divide different characters into different camps for reasoning and elimination are one of the more representative types of board games. Game rules of the reasoning games are: divide a plurality of virtual objects participating in a game into different camps, advance the game by virtual objects belonging to the different camps through strategies (for example, analysis and judgment, competition of eloquence), and the game ends when one of the camps wins (all virtual objects in the opposing camp are eliminated).

It should be noted that the information disclosed in the background section above is only used to enhance the understanding of the background of the present disclosure, and therefore may include information that does not constitute the prior art known to those skilled in the art.

### SUMMARY

The present disclosure provides a method and apparatus for controlling a game progress, an electronic device, and a storage medium.

In a first aspect, embodiments of the present disclosure provide a method for controlling a game progress, wherein a graphical user interface is provided by a terminal device, the graphical user interface includes a virtual scene of a current game stage, and the game stage includes an action stage and a discussion stage, and wherein the method includes: displaying, in the action stage, at least part of a first virtual scene of the action stage and a first virtual object located in the first virtual scene in the graphical user interface: obtaining a skill configuration parameter of the first virtual object to determine an additional skill, newly added on a basis of a character default skill, of the first virtual object, wherein the default skill is a skill assigned according to an identity attribute of the first virtual object: when determining that a completion progress of a virtual task in the game stage reaches a progress threshold, controlling the first virtual object to unlock the additional skill, and providing an additional skill control that is configured to trigger the additional skill on a basis of providing a default skill control in the graphical user interface that is configured to trigger the default skill; and controlling the graphical user interface to display a second virtual scene corresponding to the discussion stage in response to a preset trigger event, wherein the second virtual scene includes at least one of: a second virtual object, a character icon of the second virtual object, the first virtual object, and a character icon of the first virtual object, and wherein the discussion stage is configured to determine a game state of at least one second virtual object or the first virtual object according to a result of the discussion stage.

In a second aspect, embodiments of the present disclosure further provide an electronic device, including: a processor, a storage medium, and a bus, wherein machine-readable instructions executable by the processor are stored in the storage medium, and when the electronic device is running, the processor is in communication with the storage medium through the bus, and the processor executes the machine-readable instructions to execute steps of the method for controlling the game progress as described in any one of the first aspects.

It should be understood that the above general description and the following detailed description are merely exemplary and explanatory, and should not limit the present disclosure.

### BRIEF DESCRIPTION OF THE DRAWINGS

In order to explain technical solutions in embodiments of the present disclosure more clearly, drawings needed in these embodiments will be briefly introduced below. It should be understood that the following drawings only show some embodiments of the present disclosure, and should not be regarded as a limitation of the scope. For those of ordinary skill in the art, other relevant drawings may be obtained from these drawings without creative labor.

FIG. 1 is a flowchart of a method for controlling a game progress provided by an embodiment of the present disclosure:

FIG. 2 is a schematic diagram of a game scene in an action stage:

FIG. 3 is a schematic diagram of a game scene in a discussion stage:

FIG. 4 is a schematic diagram of a game scene in an identity gambling stage:

FIG. 5 is a first schematic interface diagram of a first virtual scene provided by an embodiment of the present disclosure;

FIG. 6 is a first schematic interface diagram of a second virtual scene provided by an embodiment of the present disclosure:

FIG. 7 is a second schematic interface diagram of a first virtual scene provided by an embodiment of the present disclosure:

FIG. 8 is a third schematic interface diagram of a first virtual scene provided by an embodiment of the present disclosure;

FIG. 9 is a second schematic interface diagram of a second virtual scene provided by an embodiment of the present disclosure:

FIG. 10 is a schematic diagram of movement of a virtual object provided by an embodiment of the present disclosure:

FIG. 11 is a first schematic structural diagram of an apparatus for controlling a game progress provided by an embodiment of the present disclosure:

FIG. 12 is a second schematic structural diagram of an apparatus for controlling a game progress provided by an embodiment of the present disclosure: and

FIG. 13 is a schematic structural diagram of an electronic device provided by an embodiment of the present disclosure.

### DETAILED DESCRIPTION

In order to make objectives, technical solutions and advantages of embodiments of the present disclosure clearer, the technical solutions will be described below in a clear and complete manner in conjunction with the accompanying drawings in the embodiments of the present disclosure. It is apparent that the described embodiments are only a part of the embodiments of the present disclosure, and not all of the embodiments. The components of embodiments of the present disclosure generally described and illustrated in the accompanying drawings herein may be arranged and designed in a variety of different configurations. Accordingly, the following detailed description of embodiments of the present disclosure provided in the accompanying drawings is not intended to limit the scope of the present disclosure for which protection is claimed, but rather represents only selected embodiments of the present disclosure. Based on the embodiments of the present disclosure, each other embodiment obtained by a person skilled in the art without creative labor are within the scope of protection of the present disclosure.

Virtual scene: it is a virtual scene displayed (or provided) when an application is running on a terminal or server. In some embodiments of the present disclosure, the virtual scene is a simulation environment for the real world, or a semi-simulated and semi-fictional virtual environment, or a pure fictional virtual environment. The virtual scene is any one of two-dimensional virtual scene and three-dimensional virtual scene. The virtual environment can be the sky, land, sea, etc., where the land includes deserts, cities and other environmental elements. The virtual scene is a scene of a complete game logic of a virtual object controlled by the user.

Virtual object: it refers to a dynamic object that can be controlled in the virtual scene. In some embodiments of the present disclosure, the dynamic object may be a virtual character, a virtual animal, an animated character, and so on. The virtual object is a character controlled by a game player through an input device, or an artificial intelligence (AI) that has been trained to battle in a virtual environment, or a non-player character (NPC) that has been set up to battle in a virtual scene. In some embodiments of the present disclosure, the virtual object is a virtual character competing in a virtual scene. In some embodiments of the present disclosure, the number of virtual objects in the battle of the virtual scene may be preset or may be dynamically determined according to the number of clients participating in the battle, which is not limited by embodiments of the present disclosure. In an implementation of the present disclosure, the user may control the movement of the virtual object in the virtual scene, such as running, jumping, crawling, etc., and may also control the virtual object to use a skill, a virtual prop, etc., provided by the application to fight with other virtual objects.

Player character: it refers to a virtual object that can be controlled by the game player to move around in the game environment. In some video games, it may also be called a god character (or Shikigami character) or hero character. The player character may be at least one of the different forms such as a virtual character, a virtual animal, an animated character, a virtual vehicle, etc.

Game interface: it refers to an interface corresponding to an application provided or displayed through a graphical user interface, which includes a game screen and an UI interface for interaction between game players. In an embodiment of the present disclosure, the UI interface may include game controls (e.g., skill controls, movement controls, function controls, etc.), indication identifiers (e.g., direction indication identifiers, character indication identifiers, etc.), information display areas (e.g., the number of kills, a competition time, etc.), or game setting controls (e.g., system settings, stores, coins, etc.). In an embodiment of the present disclosure, the game screen is a display screen corresponding to the virtual scene displayed by the terminal device, and the game screen may include virtual objects such as game characters, NPC characters, AI characters, and so on, which perform the game logic in the virtual scene.

Virtual entity: it refers to a static object in the virtual scene, such as terrain, houses, bridges, vegetation, etc. in the game scene. The static object tends to be not directly controlled by the game player, but can respond to the interactive behavior (e.g., attack, demolition, etc.) of the virtual object in the scene to make the corresponding performance. For example, the virtual object can demolish, pick up, drag or drop, or construct “buildings”. In some embodiments of the present disclosure, the virtual entity may not be able to respond to the interactive behavior of the virtual object. For example, the virtual entity may also be a building, a door, a window; a plant, etc., in the game scene, but the virtual object may not be able to interact with it, e.g., the virtual object may not be able to destroy or dismantle the window: A method for controlling a game progress in an embodiment of the present disclosure may run on a local terminal device or a server. When the method for controlling the game progress runs on the server, the method may be realized and executed based on a cloud interaction system, and the cloud interaction system includes a server and a client device.

In an embodiment of the present disclosure, various cloud applications, such as cloud gaming, can be run under the cloud interaction system. Taking the cloud gaming as an example, the cloud gaming refers to a game mode based on cloud computing. In the running mode of the cloud gaming, a main body of running the game program and a main body of presenting the game screen are separated, and the storage and running of a method for processing information are completed on the cloud game server, while a function of the client device is receiving and sending data and presenting the game screen. For example, the client device may be a display device with data transmission function close to the user side, such as a mobile terminal, TV, computer, personal digital assistant (PDA), etc., but the information processing is carried out by the cloud game server in the cloud. When playing the game, the game player operates the client device to send operation instructions to the cloud game server, and the cloud game server runs the game according to the operation instructions, encodes and compresses the game screen and other data, and returns them to the client device through the network, and finally the client device decodes and outputs the game screen.

In an embodiment of the present disclosure, taking a game as an example, a local terminal device stores a game program and is configured to present a game screen. The local terminal device is configured to interact with the game player via a graphical user interface, i.e., the game program is routinely downloaded, installed, and run via an electronic device. The local terminal device provides the graphical user interface to the game player in a variety of ways, e.g., the graphical user interface may be rendered and displayed on a display screen of the terminal, or may be provided to the game player via holographic projection. For example, the local terminal device may include a display screen and a processor. The display screen is configured to present the graphical user interface that includes the game screen, and the processor is configured to run the game, generate the graphical user interface, and control the display of the graphical user interface on the display screen.

Application scenarios that the present disclosure is applicable to are introduced. The present disclosure may be set in the field of game technologies.

In a reasoning game, a plurality of game players participating in the game join the same game match, and after the players enter the game match, different character attributes, e.g., identity attributes, are assigned to virtual objects of the different game players, so that different camps can be determined through the different character attributes assigned, and the game players can win the game by performing the tasks assigned by the game during the different game stages of the game match. For example, multiple virtual objects with character attribute A can win a game by “eliminating” virtual objects with character attribute B during the game stages. Taking the board game as an example, it typically involves 10 persons playing in the same game match, and at the beginning of the game match, the identities (character attributes) of the virtual objects in the game match are determined, including, for example, civilian and werewolf identities. The virtual objects with civilian identities win the game by completing the assigned tasks during the game stages or by eliminating virtual objects with werewolf identities in the current game match. The virtual objects with the werewolf identities win the game by eliminating other virtual objects that are not werewolves by performing attack behaviors on these virtual objects during the game stages.

For the game stages of the reasoning game, there are typically two game stages: an action stage and a discussion stage.

In the action stage, one or more game tasks are usually assigned. In an embodiment of the present disclosure, one or more game tasks are assigned to each virtual object, and the game player completes the game match by controlling the corresponding virtual object to move in the game scene and perform the corresponding game tasks. In an embodiment of the present disclosure, a common game task can be determined for virtual objects with the same character attribute in the current game match. In the action stage, the virtual objects participating in the current game match can move freely to different areas in the game scene of the action stage to complete the assigned game task. The virtual objects in the current game match include a virtual object with a first character attribute and a virtual object with a second character attribute. In an embodiment of the present disclosure, when the virtual object with the second character attribute moves to a preset range of the virtual object with the first character attribute in the virtual scene, the virtual object with the second character attribute may respond to an attack instruction and attack the virtual object with the first character attribute to eliminate the virtual object with the first character attribute.

The discussion stage provides a discussion function for the virtual object representing the game player, through which the behavior of the virtual object during the action stage is presented to determine whether or not to eliminate a specific virtual object in the current game match.

Taking the board game as an example, the game match consists of two stages, namely the action stage and the discussion stage. In the action stage, multiple virtual objects in the game match move freely in the virtual scene, and other virtual objects appearing in a preset range can be seen on the game screen presented from one virtual object's viewpoint. The virtual object with the civilian identity completes the assigned game task by moving in the virtual scene. The virtual object with the werewolf identity damages the completed task of the virtual object with the civilian identity in the virtual scene, or may perform a specific assigned game task. In addition, the virtual object with the werewolf identity may also attack the virtual object with the civilian identity during the action stage to eliminate the virtual object with the civilian identity: When the game match enters the discussion stage from the action stage, the game players participate in the discussion through the corresponding virtual objects in an attempt to determine the virtual object with the werewolf identity based on the game behaviors in the action stage, and determine the result of the discussion by voting, and determine whether there is a virtual object that needs to be eliminated according to the result of the discussion, and if so, the corresponding virtual object will be eliminated according to the result of the discussion. If not, there is no virtual object that will be eliminated in the current discussion stage. In the discussion stage, the discussion can be conducted by voice, text, or other means.

A schematic diagram of an implementation environment is provided in an embodiment of the present disclosure. The implementation environment may include: a first terminal device, a game server, and a second terminal device. The first terminal device and the second terminal device communicate with the server respectively to implement data communication. In this implementation, the first terminal device and the second terminal device are each installed with a client that executes the method for displaying the game progress provided by the present disclosure, and the game server is a server that executes the method for displaying the game progress provided by the present disclosure. Through the client, the first terminal device and the second terminal device may respectively communicate with the game server.

Taking the first terminal device as an example, the first terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, etc. When the first terminal device receives a response from the server, a virtual scene corresponding to the game match is displayed through a graphical user interface of the first terminal device. In an implementation of the present disclosure, the server determines, based on the game request of the client, a target game match for the client from a plurality of game matches that have been established. When the first terminal device receives the response from the server, the virtual scene corresponding to the game match is displayed through the graphical user interface of the first terminal device. The first terminal device is a device controlled by a first user. A virtual object displayed in the graphical user interface of the first terminal device is a player character controlled by the first user. The first user inputs an operation instruction through the graphical user interface to control the player character to perform a corresponding operation in the virtual scene.

Taking the second terminal device as an example, the second terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, etc. When the second terminal device receives a response from the server, a virtual scene corresponding to the game match is displayed through a graphical user interface of the second terminal device. In an implementation of the present disclosure, the server determines, based on the game request of the client, a target game match for the client from a plurality of game matches that have been established. When the second terminal device receives the response from the server, the virtual scene corresponding to the game match is displayed through the graphical user interface of the second terminal device. The second terminal device is a device controlled by a second user. A virtual object displayed in the graphical user interface of the second terminal device is a player character controlled by the second user. The second user inputs an operation instruction through the graphical user interface to control the player character to perform a corresponding operation in the virtual scene.

The server performs data calculation based on the received game data reported by the first terminal device and the second terminal device, and synchronizes the calculated game data to the first terminal device and the second terminal device, so that the first terminal device and the second terminal device control the rendering of the corresponding virtual scenes and/or virtual objects in the graphical user interfaces according to the synchronization data sent by the server.

In an embodiment of the present disclosure, the virtual object controlled by the first terminal device and the virtual object controlled by the second terminal device are virtual objects in the same game match. The virtual object controlled by the first terminal device and the virtual object controlled by the second terminal device may have the same character attributes, or may have different character attributes.

It should be noted that the virtual objects in the current game match may include two or more virtual objects, and different virtual objects may correspond to different terminal devices, respectively: That is to say; there are more than two terminal devices in the current game match that respectively send and synchronize the game data with the game server.

Embodiments of the present disclosure provide a method for controlling a game progress, which can assign an additional skill in a game to a corresponding first virtual object. After the game progress reaches a progress threshold, the corresponding additional skill is actively unlocked, so that the first virtual object with the additional skill uses the corresponding additional skill in the action stage of the game. The release of the additional skill can help the player eliminate a virtual object in the opposing camp through corresponding reasoning. In this way, the game progress may be accelerated, thereby reducing the consumption of the power and the data traffic of the terminal during the game.

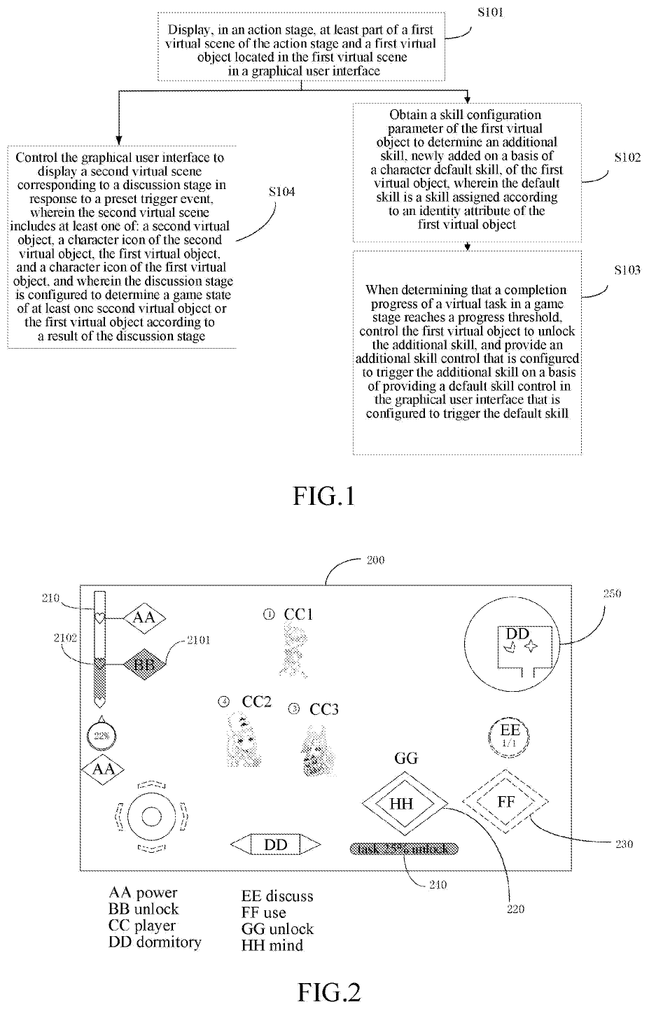

Reference is made to FIG. 1, which is a flowchart of a method for controlling a game progress provided by an embodiment of the present disclosure. As shown in FIG. 1, the method for controlling the game progress provided by the embodiment of the present disclosure includes S101 to S104.

In the S101, in an action stage, at least part of a first virtual scene of the action stage and a first virtual object located in the first virtual scene are displayed in a graphical user interface.

In the S102, a skill configuration parameter of the first virtual object is obtained to determine an additional skill, newly added on a basis of a character default skill, of the first virtual object, and the default skill is a skill assigned according to an identity attribute of the first virtual object.

In the S103, when it is determined that a virtual task completion progress in a game stage reaches a progress threshold, the first virtual object is controlled to unlock the additional skill, and an additional skill control that is configured to trigger the additional skill is provided on a basis of providing a default skill control in the graphical user interface that is configured to trigger the default skill.

In the S104, in response to a preset trigger event, the graphical user interface is controlled to display a second virtual scene corresponding to the discussion stage, the second virtual scene includes at least one of: a second virtual object, a character icon of the second virtual object, the first virtual object, and a character icon of the first virtual object, and the discussion stage is configured to determine a game state of at least one second virtual object or the first virtual object according to a result of the discussion stage.

In embodiments of the present disclosure, the corresponding game scene may be a reasoning game. Specifically, the reasoning game is a strategy game that a plurality of persons participate in and is promoted by verbal descriptions and involves eloquence competition and analytical judgment ability competition. All virtual objects in the reasoning game may be roughly divided into two categories, virtual objects with special identities and virtual objects without the special identities. The virtual objects without the special identities need to identify hostile virtual objects with the special identities. The virtual scene as a reasoning game scene is taken as an example for illustration below.

In the step S101, in the reasoning game scene of embodiments of the present disclosure, the game stage may include two stages, that is, the action stage and the discussion stage. In the action stage, respective virtual objects act in respective activity areas to complete a plurality of tasks. When the game progress is in the action stage, the first virtual scene corresponding to the action stage and the first virtual object in the first virtual scene are displayed in the graphical user interface.

Here, the first virtual scene displayed in the graphical user interface will be switched as the first virtual object moves. For example, if the first virtual object is currently walking on the road, then the road on which the first virtual object walks, a plurality of task areas beside the road, a name of each task area and the like are displayed in the corresponding first virtual scene. After walking for a period of time, the first virtual object enters a certain task area, then the corresponding first virtual scene will be switched to display a scene in the activity area that the first virtual object enters, which may include furnishings in the task area and other virtual objects in this task area.

In addition, in embodiments of the present disclosure, a scene thumbnail corresponding to the first virtual scene is also displayed in the first virtual scene, which may be displayed in a specific area (e.g., the upper right corner, etc.) of the graphical user interface. Likewise, the display content of the scene thumbnail will also change with the movement of the first virtual object.

Here, the action stage and the discussion stage may be switched based on the triggering of the preset trigger event. For example, after the discussion stage is switched to, the virtual objects can speak and vote to determine which virtual object will be eliminated, until a camp with a certain identity reaches a victory condition, and the game is over.

In the step S102, the obtained skill configuration parameter indicates the default skill that the first virtual object can use throughout the game stage, as well as the newly added skill that may be unlocked when a certain condition is satisfied. These skills may help the first virtual object complete the corresponding virtual task in the game and obtain corresponding game clue information and a game point. In an implementation of the present disclosure, when the terminal device establishes the communication with the game server and enters a game match assigned by the game server, the game server assigns different character attributes for virtual objects in the current game match upon the start of the game match, while determining the corresponding skill configuration parameter and sending it to the corresponding terminal device. In an embodiment of the present disclosure, the game server sends the configuration parameter to the terminal device that controls the first virtual object.

In embodiments of the present disclosure, the first virtual object is a virtual object with a first character attribute, and the virtual task includes tasks completed by all virtual objects with the first character attribute in the game stage. For example, in a case that the reasoning game is the board game, the first virtual object may be a virtual object with a civilian identity; and the virtual task includes all tasks completed by all civilians during the game stage. The default skill of the first virtual object is a skill assigned according to the identity attribute of the first virtual object, and other virtual objects belonging to the same identity attribute in the game may be assigned to default skills. The additional skill is a skill that a plurality of virtual objects with the same identity attribute in the game jointly unlock when they complete a corresponding task together. In an implementation of the present disclosure, the additional skill is randomly assigned to any of the plurality of virtual objects with the same identity attribute (e.g., civilian identity). A virtual object to which the newly added skill is assigned knows the default skill and the additional skill it possesses, while the virtual object which the additional skill is not assigned to knows what specifically the additional skill is, but does not know a specific virtual object to which the additional skill is assigned. In an implementation of the present disclosure, the additional skill is a skill determined according to the selection of the user. For example, at the beginning of the current game match, an additional skill selection function is provided, and the player determines a skill assigned in the current game match through the additional skill selection function.

Additional skills may be divided into two types, which are active skills and passive skills, respectively: The active skill refers to an additional skill that the first virtual object has an ability to actively select an object to which the additional skill is applied, and the passive skill refers to an additional skill that the first virtual object does not have the ability to actively select the object to which the additional skill is applied. Here, in embodiments of the present disclosure, the additional skill may include at least one of: an identity gambling skill, an identity verification skill, a guidance skill, and a task doubling skill, where the identity gambling skill and the identity verification skill belong to the active skills, and the guidance skill and the task doubling skill belong to the passive skills.

The identity gambling skill means that the first virtual object using the identity gambling skill can identify some other virtual object (i.e., a second virtual object) besides itself as a hostile virtual object with the special identity: If the identity is correct, then the gambling is successful, a game state of the identified virtual object is updated, for example, the game state of the identified virtual object is updated to a dead state, and for the identified virtual object, the game is over. If the identity is not correct, then the gambling fails, a game state of the first virtual object is updated, for example, the game state of the first virtual object is updated to the dead state, and for the first virtual object, the game is over. Although there is a risk in using the identity gambling skill, once used, it will definitely eliminate a virtual object in the game, thereby facilitating to speed up the game progress and in turn reducing the power and the data traffic consumed by the terminal.

For example, the first virtual object with a non-special identity has the identity gambling skill and identifies an identity of virtual object No. 4 as a special identity: If the true identity of virtual object No. 4 is the special identity, the gambling of virtual object No. 1 is successful, and virtual object No. 4 is sealed (dead).

The identity verification skill means that the first virtual object using the identity verification skill can randomly select a virtual object from other virtual objects (i.e., the second virtual objects) who are still in an alive state in the game to request to see identity information of this virtual object. Once the first virtual object uses the identity verification skill, the identity information of the virtual object who is required to show its identity will be displayed to the first virtual object who uses the identity verification skill, so that the first virtual object may better distinguish identities of other virtual objects. After the first virtual object learns the identity information of this virtual object, it can perform tendentious guidance for other virtual objects based on the identity of this virtual object in the subsequent game process to more quickly identify the virtual object with the special identity, thereby speeding up the game progress and reducing the power and the data traffic consumed by the terminal.

The guidance skill means that when the first virtual object using the guidance skill is doing a task, it can determine position information of other virtual objects to which the game has been over according to the guidance, and move to that position according to the prompt route, in order to trigger a group discussion stage, thereby facilitating to speed up the game progress and in turn reducing the power and the data traffic consumed by the terminal.

The task doubling skill means that the first virtual object using the task doubling skill can obtain a certain proportion of additional points when doing the same task. In this way, it not only increases task points of the first virtual object, but also indirectly increases task completion progresses of all virtual objects with the same identity as the first virtual object, thereby speeding up the game progress and in turn reducing the power and the data traffic consumed by the terminal.

In the step S103, the virtual task completion progress indicates a progress of the virtual task being jointly completed by the virtual objects with the same first character attribute in the game stage. That is, in embodiments of the present disclosure, the virtual task completion progress is a progress of a task jointly completed by all virtual players without special identities. It is different from the situation in the prior art where the game progress is only a display of the completion progress of one virtual object. In this way, the game progress can be accelerated. Correspondingly, when the reasoning game is the board game, the first virtual object may be a virtual object with a civilian identity, that is, the first character attribute is the civilian.

Here, the unlockable additional skills corresponding to individual different virtual task completion progresses will be preset. Once the virtual task completion progress reaches the progress threshold, the corresponding additional skill will be unlocked, and the virtual object with this additional skill may use the unlocked additional skill at the appropriate time.

When the virtual task progress is divided, completion of the virtual task progress may be set to 100%, and different task execution progress thresholds may be evenly divided. For example, if three additional skills may be unlocked in this game, then it may be set that corresponding additional skills may be unlocked when virtual task completion progresses are 25%, 50% and 75%. Correspondingly, different task execution progress thresholds may also be randomly divided. For example, if three additional skills may also be unlocked in this game, then it may be set that corresponding additional skills may be unlocked when virtual task completion progresses are 30%, 50% and 80%. In addition, the number of additional skills that can be unlocked when the progress threshold is reached is not specifically limited in embodiments of the present disclosure, which may be any number set according to the game. For example, when the virtual task completion progress reaches 30% of the overall virtual task, two additional skills may be unlocked.

In addition, the additional skills that can be unlocked at different stages may be the same or different. An unlocking order and the number of unlocking times of specific skills are preset by the game.

Here, when the additional skill is not unlocked, the virtual object to which the additional skill is assigned can know the additional skill it possesses, but when the additional skill is not unlocked, it cannot be used. When the additional skill is unlocked, the additional skill control that is configured to trigger the additional skill is provided on the basis of providing the default skill control that is configured to trigger the default skill in the graphical user interface of the player with the additional skill.

In embodiments of the present disclosure, the virtual task completion progress is displayed through a first progress prompt control provided in the graphical user interface, and at least one unlocking identifier that is configured to prompt that a corresponding additional skill can be unlocked at a preset progress may also be displayed on the first progress prompt control.

Here, the first progress prompt control may be displayed at a specific position (e.g., the upper left corner, etc.) in the graphical user interface, and the additional skill that is able to be unlocked is prompted through text information at a corresponding position of the first progress prompt control, and is marked with a special identifier on the first progress prompt control.

Here, a specific display form of the first progress prompt control may be in the form of progress bar. When the progress bar reaches 100%, it means that a virtual object team that has the same first character attribute as the first virtual object has completed the virtual task.

The progress bar may be expressed in the form of long-type progress bar or long progress bar. When the progress bar is expressed in the form of long bar, respective additional skills that can be unlocked may be arranged in a length direction of the long progress bar. When the progress bar is expressed in the form of circle, the respective additional skills that can be unlocked may be arranged in a specific clockwise or counterclockwise direction of the circular progress bar.

In addition, a second progress prompt control corresponding to the additional skill is further provided in the graphical user interface, and the second progress prompt control is configured to display a progress of unlocking the additional skill.

For example, reference is made to FIG. 2, which is a schematic diagram of a game scene in an action stage. A graphical user interface 200 displays player 1, player 2 and player 3 who are acting (where the first virtual object is player 1), which represents that player 1, player 2 and player 3 are currently in the same game scene. A first progress bar 210 (taking the progress bar as a long-type progress bar as an example) is displayed in the upper left corner of the graphical user interface 200. A current virtual task completion progress is displayed on the first progress bar 210, and an unlocking identifier 2101 that the additional skill is able to be unlocked and a progress identifier 2102 corresponding to the unlocking identifier of the unlockable additional skill are also displayed on the first progress bar 210. When the game task progress indicated in the first progress bar 210 reaches the progress identifier 2102 of the additional skill, the additional skill corresponding to the progress identifier 2102 can be unlocked. For example, the unlocking identifier 2101 may be highlighted to indicate that the task has been unlocked. The default skill control (not shown in FIG. 2) of the skill that player 1 can use and the additional skill control 220 to be unlocked are displayed in the graphical user interface 200. The player use the default skill control and the additional skill that has been unlocked by controlling a use control 230. In addition, a second progress bar 240 is arranged under the additional skill control 220 (and what is marked on the second progress bar 240 is that the additional skill is able to be unlocked when which threshold is reached by the virtual task completion, as shown in FIG. 2, “Task 25% Unlocking”). When the additional skill is unlocked, the progress of the second progress bar 240 is filled, indicating that player 1 can use the additional skill. In addition, after the game settings are completed, in order to facilitate the player to better determine the situation of the current scene during the game progress, a current scene thumbnail 250 is provided in the upper right corner of the graphical user interface 200, and the player learns the progress of the game scene in real time through the scene thumbnail 250 during the game progress.

In the step S104, the preset trigger event is a preset event that triggers the discussion stage. In the reasoning game scene of embodiments of the present disclosure, this preset trigger event can switch the time of the game stage, which is, for example, a trigger control that switches the game stage being triggered, a distance of the first virtual object from a virtual object in a target state being less than a first distance threshold, etc.

Specifically, the step of controlling the graphical user interface to display the second virtual scene corresponding to the discussion stage in response to the preset trigger event includes:

in response to a distance of the first virtual object from a virtual object in a target state being less than a first distance threshold, controlling the graphical user interface to display the second virtual scene corresponding to the discussion stage.

In embodiments of the present disclosure, the discussion stage is triggered by an event that the virtual object in the target state is discovered, and the virtual object in the target state is bound to be discovered near the virtual object in the target state, so the first distance threshold is set. When the first virtual object moves to an area where the distance from the virtual object in the target state is less than the first distance threshold, the first virtual object triggers a discussion, and the graphical user interface is controlled to switch from the first virtual scene of the action stage to the second virtual scene corresponding to the discussion stage.

A setting principle of the first distance threshold is that a dead virtual object can be found within the range of this distance threshold.

Here, when the game progress is switched from the action stage to the discussion stage, the game scene displayed in the graphical user interface will be switched from the first virtual scene to the second virtual scene. All virtual objects in this game will be displayed in the second virtual scene.

When the discussion stage is entered, basic information that needs to be obtained includes: which virtual object initiates the discussion, which virtual object is in the dead state when the discussion is initiated, a position where the virtual object in the dead state last appears, a position of each virtual object upon the imitation of the discussion, etc., and then the game reasoning is performed based on the basic information to obtain a correct reasoning result, and this information is displayed in the second virtual scene for reference.

What may be displayed in the second virtual scene is: the second virtual object, the character icon of the second virtual object, the first virtual object, and the character icon of the first virtual object. The discussion stage is configured to determine the game state of at least one second virtual object or the first virtual object according to the result of the discussion stage.

In embodiments of the present disclosure, during the display of each second virtual object, the second virtual object and the icon of the second virtual object may be displayed together in the second virtual scene. When both are displayed at the same time, the icon (e.g., an avatar of the second virtual object, etc.) corresponding to the second virtual object may be displayed at a preset position (e.g., at a head) of the second virtual object. Alternatively, only the second virtual object is displayed in the second virtual scene. Alternatively, only the icon of the second virtual object is displayed in the second virtual scene. Likewise, the display mode of the first virtual object may also be similar to the plurality of display modes of the second virtual object, which will not be described again here.

In embodiments of the present disclosure, some virtual objects may already be in the dead state at the beginning of the discussion stage, but the game characters that have been dead during the discussion stage will still appear in the second virtual scene. In order to distinguish between a virtual object in the alive state and a virtual object in the dead state, the virtual object in the alive state and the virtual object in the dead state may be displayed in different display states. For example, the virtual object in the dead state may be a blurred character image.

Here, when a virtual object is in the dead state, it is also necessary to display information such as a character name, a cause of death, and a death position of the virtual object at a preset position of the virtual object, for the alive virtual object to perform game reasoning based on the information.

In embodiments of the present disclosure, in the discussion stage, after the discussion among individual virtual objects is finished, a voting session will be conducted. During the voting process, voting results may also be displayed in the second virtual scene.

In an example of the present disclosure, there may be a situation in the discussion stage that the game state of the virtual object may be changed. After the discussion stage ends, a current state of each virtual object needs to be determined based on the discussion result.

For example, virtual object A is determined to be a virtual object with the special identity during the discussion stage, and everyone votes correctly. It is determined that virtual object A is caught, then virtual object A is sealed, and the game state of virtual object A is changed from the alive state to the dead state at the same time.

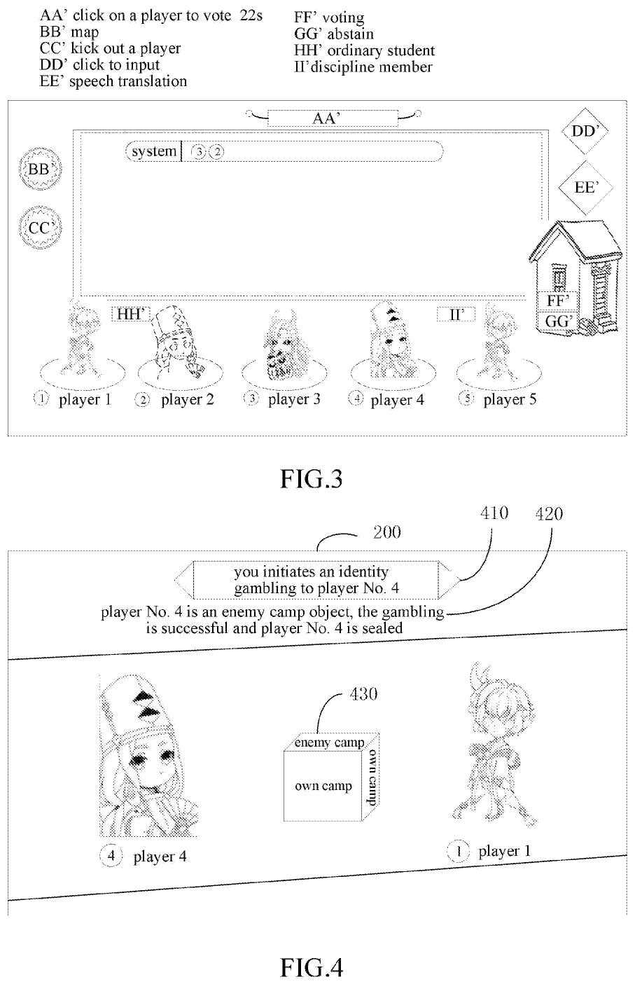

For example, reference is made to FIG. 3, which is a schematic diagram of a game scene in a discussion stage. As shown in FIG. 3, players 1 to 5 are displayed in the graphical user interface, and player 2 is already dead before participating in the discussion stage, thus player 2 is displayed in a blurred state, in order to remind other players that this player is already in the dead state, and to provide a reference for the voting session, that is, there is no need to vote for player 2. In addition, according to the cause of death of player 2, the identity of player 2 may also be indicated to eliminate interference for the identity confirmation for other players.

Further, when the first virtual object obtains different additional skills, the game progress may be promoted through the different additional skills. The different additional skills will produce different results for the game progress when used in specific implementations, which are respectively explained below.

First, in a case that the additional skill includes the identity gambling skill:

a1: after the identity gambling skill is unlocked, in response to an identity gambling skill control being triggered, the first virtual object is controlled to perform identity gambling with the second virtual object.

In embodiments of the present disclosure, when a virtual task completion progress threshold that can unlock the identity gambling skill is reached, it is determined that the identity gambling skill of the first virtual object possessing the identity gambling skill is unlocked, and an additional skill control corresponding to the identity gambling skill is displayed in the graphical user interface.

Here, the triggering of the identity gambling skill control may be that the player controlling the first virtual object applies a touch operation on the additional skill control. When it is determined that the touch operation of the player on the additional skill control is received, the identity gambling skill is triggered.

When the identity gambling skill is triggered, the first virtual object is required to provide a name of a second virtual object that it wants to gamble with and identity information of the selected second virtual object, and the identity gambling is performed with the selected second virtual object based on the information.

In embodiments of the present disclosure, after the first virtual object and the second virtual object that trigger the identity gambling are determined, the graphical user interface is controlled to display a third virtual scene of the identity gambling. The third virtual scene includes at least one of: the second virtual object, the character icon of the second virtual object, the first virtual object, the character icon of the first virtual object, gambling information, etc.

Here, during the display of the second virtual object, the second virtual object and the icon of the second virtual object may be displayed together in the second virtual scene. When both are displayed at the same time, the icon corresponding to the second virtual object may be displayed at a preset position (e.g., at a head) of the second virtual object. Alternatively, only the second virtual object is displayed in the second virtual scene. Alternatively, only the icon of the second virtual object is displayed in the second virtual scene. Likewise, the display mode of the first virtual object may also be similar to the plurality of display modes of the second virtual object, which will not be described again here.

The gambling information includes a character name of a virtual object that initiates the identity gambling, a character name of a virtual object being gambled against, and gambling result information (the gambling is successful or the gambling fails), etc.

Here, in order to increase the fun and richness of the game display, an icon (such as a dice) indicating the gambling process may also be displayed in the third virtual scene, and different identity information is displayed on different sides of the dice. During the gambling process, the rotation of the dice indicates that the gambling is ongoing, and identity information on an upward side when the dice stops rotating is the true identity information of the target second virtual object, that is, the second virtual object participating the identity gambling.

For example, reference is made to FIG. 4, which is a schematic diagram of a game scene in an identity gambling stage. Player 4 and player 1 (the first virtual object) are displayed in the graphical user interface 200, and a gambling prompt area 410 is displayed in the graphical user interface 200. Player 1 who proposed the identity gambling and player 4 who accepts the gambling are displayed in the gambling prompt area 410. In addition, a gambling result prompt area 420 is also displayed in the graphical user interface 200, and result information of the gambling is indicated in the gambling result prompt area 420. For example, a dice 430 may also be displayed in the graphical user interface 200 to indicate the gambling progress and the true identity information of the player who is gambled against. When the identity gambling is conducted, player 1 (taking the reasoning game as the board game as an example, an identity of player 1 is the civilian) believes that player 4 is a virtual object belonging to the enemy camp (taking the reasoning game as the board game as an example, an identity of player 4 is the werewolf), and thus player 1 proposes the identity gambling to player 4. When the true identity of player 4 is indeed the virtual object of the enemy camp (taking the reasoning game as the board game as an example, the identity of player 4 is the werewolf), player 1 succeeds in the gambling, and player 4 is sealed.

a2: when the second virtual scene corresponding to the discussion stage is displayed, information related to the identity gambling result is displayed on the first virtual object or the character icon of the first virtual object included in the second virtual scene, or the information related to the identity gambling result is displayed on the target second virtual object or the character icon of the target second virtual object included in the second virtual scene.

In embodiments of the present disclosure, in a case that the identity gambling skill is triggered, when the second virtual scene corresponding to the discussion stage is displayed, the gambling result needs to be displayed on the first virtual object that initiates the identity gambling or on the icon of the first virtual object. Correspondingly, the information related to the identity gambling result also needs to be displayed on the target second virtual object or the character icon of the target second virtual object.

In embodiments of the present disclosure, since there is bound to be a sealed (dead) party in the identity gambling process, the gambling result of the virtual object (the target character or the target second virtual object) that is sealed in the gambling process may be displayed in the cause of death information (the cause of death: the gambling fails), etc.

During the gambling process, since the virtual object in the opposing camp is sealed on the premise that the first virtual object succeeds in gambling, being gambled against successfully and being sealed may be displayed on the sealed virtual object in the opposing camp or the icon of the sealed virtual object in the opposing camp. In this way, other virtual objects in the affirmative camp can learn the true identity of the virtual object in the opposite camp, providing a reference for the subsequent reasoning process.

Second, if the additional skill includes the identity verification skill:

b1: after the identity verification skill is unlocked, in response to an identity verification skill control being triggered, the identity information of the target second virtual object is provided to the first virtual object.

Similarly, in embodiments of the present disclosure, when a virtual task completion progress threshold that can unlock the identity verification skill is reached, it is determined that the identity verification skill of the first virtual object possessing the identity verification skill is unlocked, and an additional skill control corresponding to the identity verification skill is displayed in the graphical user interface.

Here, the triggering of the identity verification skill control is that the player controlling the first virtual object applies a touch operation on the additional skill control. When it is determined that the touch operation of the player on the additional skill control is received, the identity verification skill is triggered.

The touch operation may be a sliding operation, a click operation, a long press operation, etc.

Similarly, when the identity verification skill control is to be triggered, it is also necessary to provide the character name of the second virtual object whose identity you want to verify. In response to the identity verification skill control being triggered, the identity information of the target second virtual object is displayed to the first virtual object triggering the identity verification skill.

When the first virtual object initiates the identity verification on the second virtual object, it may initiate the verification near the second virtual object, or it may not initiate the verification near the second virtual object.

In embodiments of the present disclosure, when the first virtual object that triggers the identity verification skill is not near the second virtual object, the second virtual object is determined in response to a touch operation of the first virtual object in a character list.

The character list is a list that may contain icons or names of a plurality of second virtual objects.

b2: in the first virtual scene of the action stage and/or the second virtual scene of the discussion stage displayed in the graphical user interface, the identity information of the second virtual object is displayed at a preset position of the second virtual object.

The identity information of the second virtual object may be displayed at the preset position of the second virtual object, which is visible to all virtual objects, or is visible only to the first virtual object.

Specifically, in an embodiment of the present disclosure, after the first virtual object triggers the identity verification skill, the identity information of the target second virtual object may be displayed at the preset position of the second virtual object. In some embodiments of the present disclosure, the identity information is only displayed to the first virtual object, and other second virtual objects that have not triggered the identity verification skill or have not used the identity verification skill for this second virtual object cannot know the identity information of this second virtual object.

Here, a stage in which the identity information of the second virtual object is displayed may be set. The identity information may be displayed only in the action stage. When individual virtual objects perform tasks in the action stage, the first virtual object that triggers the identity verification skill will see the identity information of the second virtual object when encountering the second virtual object, but the first virtual object cannot see the identity information of the second virtual object during the discussion stage. Thus, for the scene where the identity information of the second virtual object is only displayed in the action stage, it is necessary for the first virtual object to record after determining the identity information of the second virtual object. The identity information may also be displayed only in the discussion stage. When respective virtual objects are in the discussion scene, the identity information of the second virtual object is displayed to the first virtual object that triggers the identity verification skill. The identity information may also be displayed in both the action stage and the discussion stage, and in this case, as long as the first virtual object that triggers the identity verification skill encounters the target second virtual object, the identity information of the second virtual object is displayed to the first virtual object that triggers the identity verification skill.

In embodiments of the present disclosure, the preset position for displaying the target second virtual object may be on the target second virtual object, or on the icon of the target second virtual object, etc., which is not specifically limited here.

Third, if the additional skill includes the guidance skill:

c1: after the guidance skill is unlocked, in response to a guidance skill control being triggered, position information of a virtual object in a target state within a second distance threshold range from the first virtual object is obtained. Here, the target state may be a sealed state (for example, dead), a frozen state, an injured state, a trapped state, etc.

Similarly, in embodiments of the present disclosure, when a virtual task completion progress threshold that can unlock the guidance skill is reached, it is determined that the guidance skill of the first virtual object possessing the guidance skill is unlocked, and an additional skill control corresponding to the guidance skill is displayed in the graphical user interface.

Here, when the first virtual object unlocks the guidance skill, the position information of the virtual object in the target state within the second distance threshold from the first virtual object will be obtained.

The second distance threshold may be set to a distance range that the first virtual object can reach within a certain period of time at present, or may be within a field of view range of the first virtual object.

Here, there may be more than one virtual object in the target state within the second distance threshold range from the first virtual object, and the plurality of virtual objects in the target state may be summarized and displayed to the first virtual object in the form of list.

When the target state is the dead state, an order of the plurality of dead virtual objects in the list may be sorted according to a length of a death time of each dead virtual object from the current time, or according to a distance of each dead virtual object from the first virtual object.

c2: according to the position information, an indication identifier corresponding to the position information is displayed in the graphical user interface to indicate an orientation of the virtual object in the target state in the first virtual scene.

When there is more than one virtual object in the target state, the corresponding indication identifier indicating the position information can facilitate the player to select a virtual object in the target state to be moved to.

c3: in response to a movement instruction, the first virtual object is controlled to move.

For example, taking the target state as the dead state as an example, in response to the movement instruction, a route for the first virtual object to go to the position where the dead virtual object is located may be planned according to the position information. Here, different routes may be planned for the first virtual object, which may be, for example, the shortest route for the first virtual object to reach the position where the dead virtual object is located from the current position, or a route in which the first virtual object encounters the least number of other second virtual objects on the way from the current position to the position where the dead virtual object is located, etc. In some embodiments of the present disclosure, the plurality of determined routes may be displayed as a route list to the first virtual object, so that the first virtual object can select the route that best suits itself.

Here, in some embodiments of the present disclosure, during the process of controlling the first virtual object to move to the position of the dead virtual object, the overall planned route may be displayed to the first virtual object, and during the movement of the first virtual object, the guidance for the movement direction is provided to the first virtual object in real time.

Correspondingly, after the first virtual object reaches the position where the dead virtual object is located, in response to a distance between the first virtual object and the dead virtual object being less than the first distance threshold, the graphical user interface can be controlled to display the second virtual scene corresponding to the discussion stage.

Fourth, if the additional skill includes the task doubling skill:

After the task doubling skill is unlocked, in response to a task doubling skill control being triggered, when the first virtual object completes a virtual task corresponding to the first virtual object, the reward of this virtual task is doubled according to a preset ratio.

Similarly, in embodiments of the present disclosure, when a virtual task completion progress threshold that can unlock the task doubling skill is reached, it is determined that the task doubling skill of the first virtual object possessing the task doubling skill is unlocked, and an additional skill control corresponding to the task doubling skill is displayed in the graphical user interface.

Here, similarly, the triggering of the task doubling skill control may be that the player controlling the first virtual object applies a touch operation on the additional skill control. When it is determined that the touch operation of the player on the additional skill control is received, the task doubling skill is triggered.

Here, in a case that the first virtual object triggers the task doubling skill, when the first virtual object performs the task again, the virtual reward is correspondingly doubled according to a preset ratio after the task is completed, so that the first virtual object gets more rewards to complete the virtual task as quickly as possible, thereby speeding up the game progress.

Here, the preset ratio for the doubling may be set according to the difficulty of the task. For example, when the doubling skill is used for a task that is difficult to complete, the preset ratio for doubling the rewards that may be obtained is set to be relatively high.

In the method for controlling the game progress provided by embodiments of the present disclosure, the first virtual scene of the action stage and the first virtual object are displayed in the graphical user interface, and the additional skill, newly added on the basis of the default skill, of the first virtual object is determined according to the skill configuration parameter of the first virtual object. When it is determined that the virtual task completion progress in the game stage reaches the progress threshold, the first virtual object is controlled to unlock the additional skill, and the additional skill control that triggers the additional skill is displayed in the graphical user interface at the same time. In response to the preset trigger event, the graphical user interface is controlled to be switched to the second virtual scene of the discussion stage, and to simultaneously display game states of the first virtual object and each second virtual object. In this way, the game progress may be accelerated, thereby reducing the consumption of the power and the data traffic of the terminal.

A specific embodiment of a game match is provided below. As described in the above embodiments, there are usually two game stages in a game match: an action stage and a discussion stage. Based on these two game stages, this embodiment provides various functions in a game match as described below: In the action stage, there are usually functions one to eight. In the discussion stage, there are usually functions one, two and seven.

Function One. This embodiment provides a display function of a virtual map. In response to a movement operation on a first virtual object, the first virtual object is controlled to move in a first virtual scene, and a range of the first virtual scene displayed in a graphical user interface is controlled to correspondingly change according to the movement of the first virtual object: and in response to a preset trigger event, the virtual scene displayed in the graphical user interface is controlled to be switched from the first virtual scene to a second virtual scene, and the second virtual scene includes at least one second virtual object.

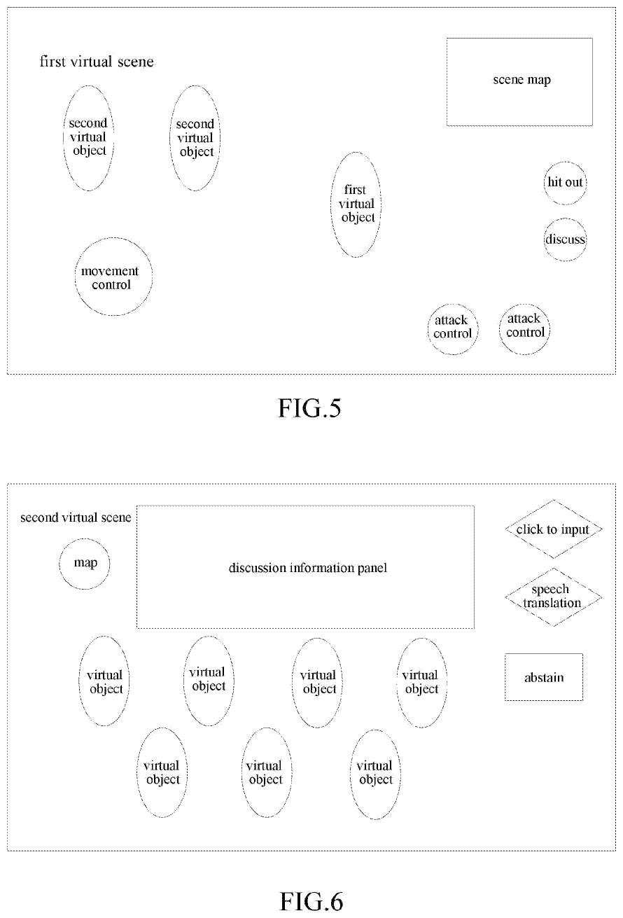

In this embodiment, the description is made from the perspective of a first virtual object with a target identity: The first virtual scene is first provided in the graphical user interface, as shown in FIG. 5, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 5, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically; the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, in FIG. 5, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

As shown in FIG. 6, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object. Specific implementations of the process may be referred to in the embodiments described above.

Function Two. This embodiment provides an information display function for a virtual object. A first virtual scene and a first virtual object located in the first virtual scene are displayed in a graphical user interface. In response to a movement operation for the first virtual object, the first virtual object is controlled to move in the first virtual scene, and a range of the first virtual scene displayed in the graphical user interface is controlled to correspondingly change according to the movement of the first virtual object. In response to a note addition operation, note prompt information is displayed for at least one second virtual object in the graphical user interface. In response to a trigger operation for the note prompt information, note information is added for a target virtual object among the displayed at least one second virtual object.

In this embodiment, the description is made from the perspective of the first virtual object with a target identity: The first virtual scene is first provided in the graphical user interface, as shown in FIG. 5, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players, or non-player controlled virtual characters. As shown in FIG. 8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual object to enter the second virtual scene.

When the user controls the first virtual object to move in the first virtual scene, the user may determine the target virtual object from at least one second virtual object in an alive state, and/or at least one third virtual object in a dead state. The at least one second virtual object in the alive state may refer to the virtual object(s) in the alive state other than the first virtual object in the current game match. Specifically, the user may determine the target virtual object based on the position, the behavior, etc. of each of the second virtual objects. For example, the user selects a virtual object as the target virtual object that is relatively isolated and is not easily detected by other virtual objects upon attacking. The user may also select a virtual object as the target virtual object that has suspicious identity information reasoned based on the position, the behavior, etc. After the target virtual object is determined, the e target virtual object may be controlled to move to the position of the target virtual object from an initial position in the first virtual scene, or the target virtual object may be selected, so that specified operations may be performed on the target virtual object, and then the target virtual object enters a target state.

For example, in response to a note addition operation, note prompt information is displayed for at least one second virtual object in the graphical user interface; and in response to a trigger operation for the note prompt information, note information is added for a target virtual object among the at least one second virtual object displayed. In this case, the note information may be displayed on the peripheral side of the target virtual object in the first virtual scene, that is, when the first virtual object is moved in the first virtual scene according to the movement operation and the range of the first virtual scene displayed in the graphical user interface is controlled to correspondingly change according to the movement of the first virtual object, if the target virtual object appears in a preset range of the first virtual object, the player may see the target virtual object as well as the note information of the target virtual object through the first virtual scene presented in the graphical user interface.

The second virtual scene is displayed in the graphical user interface upon the triggering of the preset trigger event. For example, the trigger event may be a specific trigger operation, which may be performed by any virtual object in the alive state. For example, in FIG. 6, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object, or its character model and character icon, in addition to the first virtual object, or its character model and object icon, where the character icon may be an avatar, a name, etc., of the virtual object.

In the second virtual scene, the virtual object in the alive state has the permission to speak, discuss and vote, and if the target virtual object enters the target state (e.g., added with the note information), the current player can see the target virtual object and the note information of the target virtual object through the second virtual scene presented in the graphical user interface. In addition, the second virtual scene is also configured with interaction modes, which may include speaking and discussing interactions, voting interactions, note interactions, and the like. A state in which the use of the interaction mode is restricted may be that a certain interaction mode is not allowed, or a certain interaction mode is not allowed within a certain period of time, or a certain interaction mode is limited to a specified number of times. For example, a virtual character in a dead state is restricted from using the voting interaction, and a virtual character in a dead state whose identity is known is restricted from using the note interaction.

As shown in FIG. 6, the second virtual scene includes a plurality of virtual objects in the alive state, including the first virtual object. The first virtual object can send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time. Additionally, a note control may be displayed along with the voting button to add note information to the clicked virtual object based on a touch operation for the note control.

In addition, a note list may also be displayed in the second virtual scene, and the note prompt information may be displayed in the note list in order to add note information to the displayed target virtual object in response to a trigger operation for the note prompt information. Specific implementations of the process may be referred to in the embodiments described above.

Function Three. This embodiment provides a control function of a game progress. In an action stage, at least part of a first virtual scene of the action stage and a first virtual object located in the first virtual scene are displayed in a graphical user interface. A skill configuration parameter of the first virtual object is obtained to determine an additional skill, newly added on the basis of a character default skill, of the first virtual object, and the default skill is a skill assigned according to an identity attribute of the first virtual object. When it is determined that a virtual task completion progress in a game stage has reached a progress threshold, the first virtual object is controlled to unlock the additional skill, and an additional skill control configured to trigger the additional skill is provided, on the basis of providing a default skill control configured to trigger the default skill in the graphical user interface. In response to a preset trigger event, the graphical user interface is controlled to display a second virtual scene corresponding to a discussion stage. The second virtual scene includes at least one of: a second virtual object, a character icon of the second virtual object, the first virtual object, and a character icon of the first virtual object. The discussion stage is configured to determine a game state of at least one second virtual object or the first virtual object based on a result of the discussion stage. Specific implementations of the process may be referred to in the embodiments described below.

In this embodiment of the present disclosure, the description is made from the perspective of the first virtual object with a first character attribute. A first virtual scene is first provided in the graphical user interface, as shown in FIG. 5, in which the first virtual object can move, or perform a game virtual task, or perform other interactive operations. The user triggers a movement operation for the target virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

When the user controls the first virtual object to move in the first virtual scene, the additional skill of the first virtual object newly added on the basis of the character default skill is determined based on the skill parameter of the first virtual object. The additional skill may include at least one of: an identity gambling skill, an identity verification skill, a guidance skill, and a task doubling skill. It is also determined the virtual task progress jointly completed by a plurality of other virtual objects having the same character attribute (the first character attribute) as the first virtual object in the current game stage, which is displayed based on the progress bar shown in FIG. 5. When it is determined that the virtual task completion progress in the game stage has reached the progress threshold, the first virtual object may be controlled to unlock the additional skill, and the first virtual object utilizes the additional skill to play the game. For example, the guidance skill may be used to determine, during the action stage, the virtual object in the first virtual scene that is in a target state (e.g., dead, etc.) and within a preset distance threshold from the first virtual object, so that the first virtual object may be controlled to move to the position of the virtual object in the target state, and a discussion may be initiated immediately:

The second virtual scene is displayed in the graphical user interface upon the triggering of the preset trigger event. For example, the trigger event may be a specific trigger operation, which may be performed by any virtual object in the alive state. For example, in FIG. 6, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object and an object icon of the first virtual object, where the object icon may be an avatar, a name, etc., of the virtual object.

In the second virtual scene, the virtual object in the alive state has the permission to speak, discuss and vote. As shown in FIG. 6, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. Before voting, the user can control the first virtual object to use the corresponding unlocked additional skill to check the virtual object of key suspicion. For example, the first virtual object can use the identity verification skill to check the identity of the virtual object of key suspicion, and based on the check result, determine whether to vote for the virtual object to improve the accuracy of the vote. Note that, the user can also click on an abstain button to give up the voting right for this time.

Function Four. This embodiment provides another display function of a virtual map. In response to a movement operation, a virtual character is controlled to move in a virtual scene and the virtual scene to which the virtual character is currently moved is displayed in a graphical user interface. In response to a map display operation, a first virtual map corresponding to the virtual scene is superimposed on top of the virtual scene. In response to a map switching condition being triggered, the first virtual map superimposed on top of the virtual scene is switched to a second virtual map corresponding to the virtual scene. A transparency of at least part of a map area of the second virtual map is higher than a transparency of a map area corresponding to the first virtual map, so that a degree of occlusion of information in the virtual scene by the virtual map after the switching is lower than a degree of occlusion before the switching.

In this embodiment, the description is made from the perspective of a virtual object controlled by a player. A virtual scene is provided in the graphical user interface, as shown in FIG. 5. In this virtual scene (e.g., the first virtual scene as shown in FIG. 5), the virtual character (e.g., the first virtual character and/or the second virtual character as shown in FIG. 5) controlled by the player can move in the virtual scene, or perform a game task, or perform other interactive operations. In response to a movement operation triggered by the player, the virtual object is controlled to move in the virtual scene, and in most cases, the virtual object is located in a position at a relative center of a range of the virtual scene displayed in the graphical user interface. The virtual camera in the virtual scene follows the movement of the virtual object, which in turn causes the virtual scene displayed in the graphical user interface to change in correspondence to the movement of the virtual object, thus the virtual scene to which the virtual character is currently moved is displayed in the graphical user interface.

The virtual objects participating in the current game match are in the same virtual scene. Therefore, during the movement of the virtual object, if the virtual object is closer to the other virtual objects, there may be other virtual objects entering into the range of the virtual scene displayed in the graphical user interface, which are characters controlled by the other players. As shown in FIG. 5, there are a plurality of virtual objects displayed in the range of the virtual scene, in addition to which there is displayed in the graphical user interface a movement control for controlling the movement of the virtual object, a plurality of attack controls, and a discussion control. The discussion control may be configured to control the virtual objects to enter the second virtual scene as shown in FIG. 6.

In response to a map display operation triggered by the user, a first virtual map is displayed superimposed on top of the virtual scene displayed in the graphical user interface. For example, in response to a touch operation by the game player on a thumbnail of the scene (such as the scene map shown in FIG. 4), the first virtual map is displayed superimposed over the virtual scene. For example, in response to a control operation that controls the virtual character to perform a second specific action, the first virtual map is displayed superimposed over the virtual scene. Here, the first virtual map includes at least a current position of the first virtual character, a position of each first virtual area in the virtual scene, a position of a connected area, and the like.

When the map switching condition is triggered, the first virtual map superimposed on the virtual scene in the graphical user interface is switched to the second virtual map corresponding to the virtual scene, where at least a portion of the map area of the second virtual map has a higher transparency than the transparency of the map area corresponding to the first virtual map, so that the degree of occlusion of the information in the virtual scene by the switched virtual map is lower than the degree of occlusion before the switching. For example, the map switching condition may be a specific triggering operation, which may be performed by the virtual object in the alive state. For example, in response to a control operation controlling the virtual object to perform a first specific action, the first virtual map superimposed on the virtual scene is switched to the second virtual map corresponding to the virtual scene. For another example, the first virtual map superimposed on the virtual scene is switched to the second virtual map corresponding to the virtual scene by triggering a map switching button.

When the map switching condition is triggered, the first virtual map may be switched to the second virtual map by a specific switching method, which may be, for example, replacing the first virtual map superimposed on the virtual scene with the second virtual map corresponding to the virtual scene: or, adjusting the first virtual map to a state where the first virtual map is not visible in the current virtual scene in accordance with a first change threshold of transparency, and replacing the first virtual map superimposed on the virtual scene with the second virtual map corresponding to the virtual scene: or clearing the first virtual map superimposed on the virtual scene, and superimposing and displaying the second virtual map in the virtual scene in accordance with a second change threshold of transparency: or, in accordance with a third change threshold of transparency, adjusting the transparency of the first virtual map, and at the same time, in accordance with a fourth change threshold of transparency, superimposing and displaying the second virtual map on the virtual scene, until the first virtual map is in a state where the first virtual map is not visible in the current virtual scene.

Function Five. This embodiment provides a target attack function in a game. In response to a movement operation for a first virtual object, the first virtual object is controlled to move in a first virtual scene and a range of the first virtual scene displayed in a graphical user interface is controlled to change in accordance with the movement of the first virtual object. A temporary virtual object is controlled to move from an initial position to a position of a target virtual object in the first virtual scene and to perform a specified operation on the target virtual object, so as to make the target virtual object to enter a target state. The temporary virtual object is a virtual object controlled by the first virtual object with a target identity; and the target identity is an identity attribute assigned at the start of the game. The target virtual object is a virtual object determined from a plurality of second virtual objects in an alive state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its object icon.

In this embodiment, the description is made from the perspective of a first virtual object with a target identity: A first virtual scene is first provided in the graphical user interface, as shown in FIG. 5, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 5, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

The temporary virtual object is a virtual object controlled by the first virtual object with a target identity; and the target identity is an identity attribute assigned at the start of the game. The target virtual object is a virtual object determined from a plurality of second virtual objects in an alive state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its character icon.

In an initial state, the temporary virtual object is not controlled by the user, but under certain specific conditions, the first virtual object with the target identity itself or the user corresponding to the first virtual object with the target identity has the permission to control the temporary virtual object. Specifically, the temporary virtual object may be controlled to move from an initial position to a position of the target virtual object in the first virtual scene, and to perform a specified operation on the target virtual object. The initial position may be a position where the temporary virtual object is located when it is not controlled. The specified operation may be an attack operation that produces, after the specified operation is performed on the target virtual object, a specific effect on the target virtual object, i.e., the above-described “make the target virtual object to enter a target state”. When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically, the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, in FIG. 5, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

As shown in FIG. 6, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In the above target attack method in the game, in the first virtual scene, the first virtual object with the target identity can control the temporary virtual object to perform the specified operation on the target virtual object, without controlling the first virtual object to directly perform the specified operation on the target virtual object, and the attack method is easy to operate, which can help the first virtual object to reduce the risk of exposing the target identity; and to improve the success rate of the attack.

Function Six. This embodiment provides an interactive data processing function in a game. In response to a touch operation for a movement control area, a first virtual object is controlled to move in a virtual scene, and a range of the virtual scene displayed in a graphical user interface is controlled to change according to the movement of the first virtual object. It is determined that the first virtual object moves to a responsive area of a target virtual entity in the virtual scene, and the target virtual entity is provided in the virtual scene to be interacted with the virtual object. In response to a control instruction triggered by the touch operation, a display state of the first virtual object is controlled to switch to an invisible state and a marker for referring to the first virtual object is displayed in an area of the target virtual entity.

The movement control area is configured to control the movement of the virtual object in the virtual scene, and the movement control area may be a virtual joystick, through which a direction of the movement of the virtual object may be controlled, and a speed of the movement of the virtual object may also be controlled.

The virtual scene displayed in the graphical user interface is mainly obtained by taking images of a virtual scene range corresponding to the position of the virtual object through the virtual camera. During the movement of the virtual object, the virtual camera may usually be configured to follow the movement of the virtual object, in which case the range of the virtual scene taken by the virtual camera will also follow the movement.

Some virtual entities with interaction functions may be provided in the virtual scene, and the virtual entities may interact with the virtual objects. The interaction may be triggered when the virtual object is located in the responsive area of the virtual entity: At least one virtual entity having an interaction function may be included in the virtual scene, and the target virtual entity is any one of the at least one virtual entity having an interaction function.

The range of the responsive area of the virtual entity may be set in advance, for example, the range of the responsive area may be set according to the size of the virtual entity, or the range of the responsive area may be set according to the type of the virtual entity, which may be set according to the actual requirements. For example, the range of the responsive area of the virtual entity of a vehicle type may be set to be greater than the area where the virtual entity is located, and the range of the responsive area of the virtual entity of a prop type used for pranks may be set to be equal to the area where the virtual entity is located.

The touch operation, for triggering the control instruction, may be a specific operation for a specified area or a specific operation for a specified object. For example, the control instruction may be triggered by double clicking on the target virtual entity: For another example, an interactive control may be provided in the graphical user interface, and the control instruction may be triggered by clicking on the interactive control. The interactive control may be provided after it is determined that the first virtual object moves to the responsive area of the target virtual entity in the virtual scene. Based on this, the method may further include: controlling the graphical user interface to display the interactive control of the target virtual entity, and the control instruction triggered by the touch operation includes a control instruction triggered by touching the interactive control.

This embodiment of the present disclosure can realize that after a game player triggers an interaction with a virtual object, the display state of the virtual object may be controlled to switch to an invisible state, and the switching of the display state as well as the operation for switching will not affect the process of the game by themselves, which increases the interaction with the game player, improves the interestingness, and enhances the user experience.

In some embodiments, the target virtual entity may be a virtual vehicle, and the virtual vehicle may be preset with a preset threshold value, which is configured to indicate the maximum number of bearers of the virtual vehicle, that is, the maximum number of virtual objects that are invisible on the virtual vehicle. Based on this, if it is determined that the virtual vehicle is fully loaded, a player who subsequently performs an invisible switch may be instructed that the invisibility has failed.

In some embodiments, the reasoning game may include two sessions that may be divided into two parts, an action session and a voting session. In the action session, all virtual objects in the alive state (players in the game) can act, e.g., they can do tasks, they can mess up, etc. In the voting session, players can gather to discuss and vote on the results of their reasoning, e.g., to reason about the identity of each virtual object, and the different identities of virtual objects may correspond to different tasks. In this type of game, a skill may also be released in the area of the target virtual entity to perform a task, or to cause a disturbance, and the like. Based on this, after it is determined that the first virtual object moves to the responsive area of the target virtual entity in the virtual scene, the method may further include: responding to a skill release instruction triggered by the touch operation, determining at least one virtual object that is invisible in the area of the target virtual entity as a candidate virtual object: and randomly determining one of the at least one candidate virtual object as the object on which the skill release instruction is to be acted upon.

The virtual object on which the skill release instruction triggered by the touch operation acts may be a character in the invisible state or a virtual object in the non-invisible state.

Function Seven. This embodiment provides a scene recording function in a game. A game interface is displayed on a graphical user interface, the game interface including at least part of a first virtual scene in a first game task stage, and a first virtual object located in the first virtual scene. In response to a movement operation for the first virtual object, a range of the virtual scene displayed in the game interface is controlled to change according to the movement operation. An image of a preset range of a current game interface is obtained in response to a record instruction triggered in the first game task stage. The image is stored. The image is displayed in response to a view instruction triggered in a second game task stage, and the second game task stage and the first game task stage are different task stages in a game match that the first virtual object is currently in.

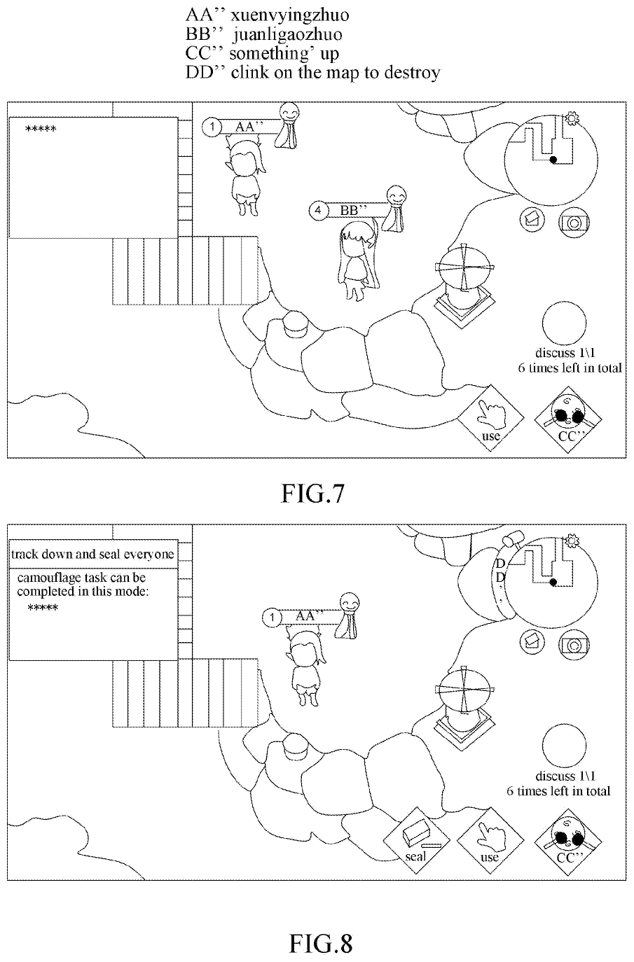

In this embodiment, the description is made from the perspective of a first virtual object with a target identity: A first virtual scene is first provided in the graphical user interface, as shown in FIGS. 7-8, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIGS. 7-8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically; the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, as shown in FIGS. 7-8, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

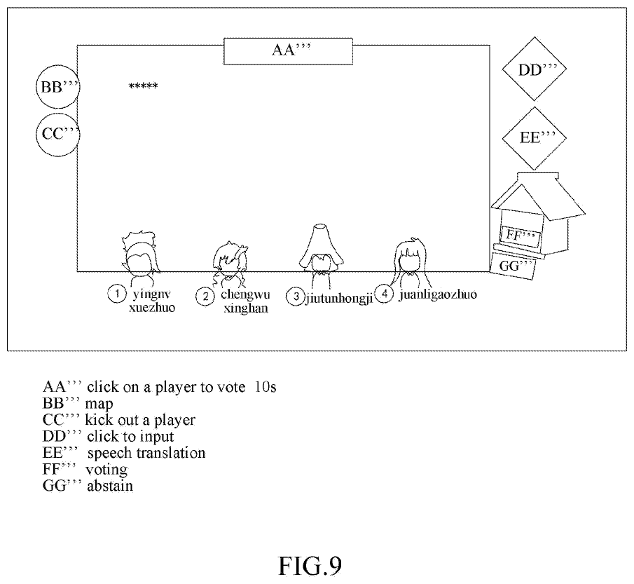

As shown in FIG. 9, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object.

Function Eight. This embodiment provides a game operation function. A graphical user interface is provided via a terminal, the graphical user interface includes a virtual scene and a virtual object, the virtual scene includes a plurality of transport areas, and the plurality of transport areas include a first transport area and at least one second transport area at a different position in the scene corresponding to the first transport area. In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the virtual scene displayed in the graphical user interface that includes the first transport area is controlled to change to a virtual scene that includes the second transport area corresponding to the target directional control.

In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the range of the virtual scene displayed in the graphical user interface that includes the first transport area is controlled to change to a range of a virtual scene that includes the second transport area corresponding to the target directional control.

In this embodiment, the graphical user interface includes at least a portion of a virtual scene and a virtual object. The virtual scene includes a plurality of transport areas, and the plurality of transport areas include a first transport area and at least one second transport area at a different position in the scene corresponding to the first transport area. The first transport area may be an entrance area of a hidden area (e.g., a tunnel, a subway; etc., the tunnel being used as an example in the present disclosure). The second transport area may be an exit area of the hidden area.

The graphical user interface may include a movement control area, and the position of the movement control area in the graphical user interface may be customized based on actual requirements, for example, it may be set in the lower left, lower right, and other thumb-touchable areas of the graphical user interface for the game player.

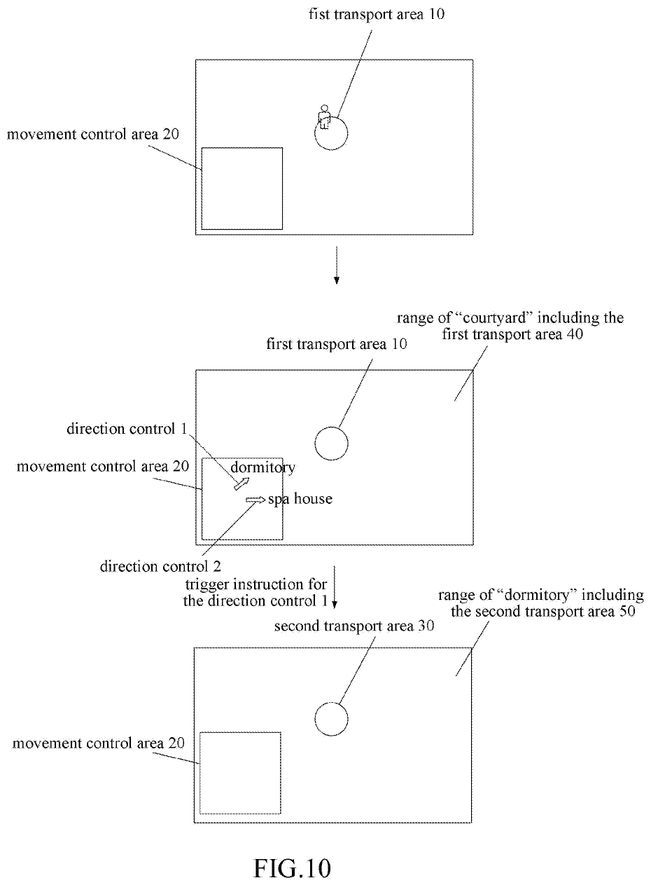

As shown in FIG. 10, a user inputs a touch operation directed to a movement control area to control movement of a virtual object in a virtual scene, and if it is determined that the virtual object moves to a first transport area, a first set of directional controls (directional control 1 and directional control 2) corresponding to at least one second transport area is displayed in the movement control area. The first set of directional controls is configured to indicate the direction of the corresponding tunnel exit.

The user inputs a trigger instruction for the target directional control (directional control 1) of the first set of directional controls to change a range of the virtual scene displayed in the graphical user interface that includes the first transport area to a range of the virtual scene that includes the second transport area corresponding to the target directional control. That is, through the trigger instruction for the target directional control, the current display in the graphical user interface is made to be the range of the virtual scene of the second transport area corresponding to the directional control 1. The specific implementation of the process may be referred to in the above embodiments.

Based on the same inventive concept, embodiments of the present disclosure further provide an apparatus for controlling a game progress corresponding to the method for controlling the game progress. Since the problem-solving principle of the apparatus in embodiments of the present disclosure is similar to the method for controlling the game progress described above in embodiments of the present disclosure, for implementations of the apparatus, reference may be made to the implementations of the method, and repeated details will not be given again.

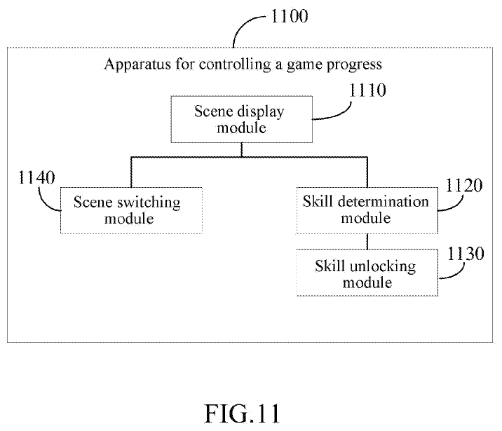

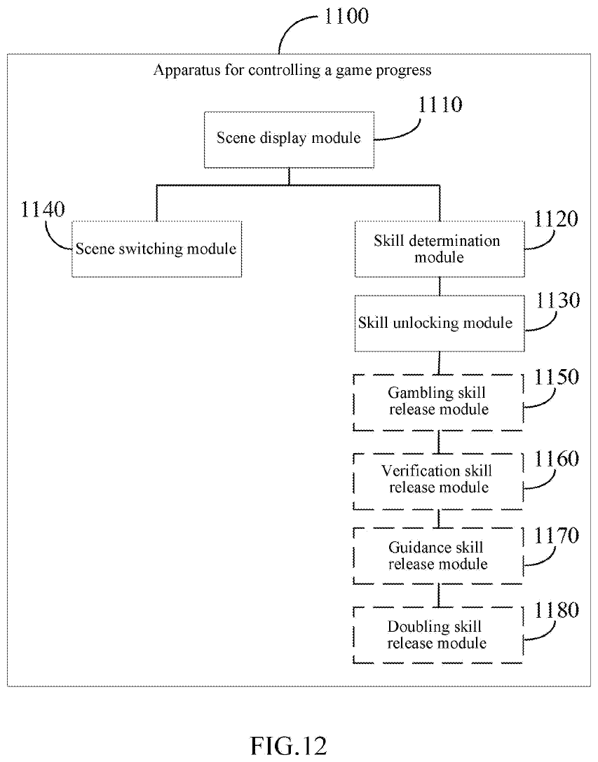

Reference is made to FIGS. 11 and 12. FIG. 11 is a first schematic structural diagram of an apparatus for controlling a game progress provided by an embodiment of the present disclosure. FIG. 12 is a second schematic structural diagram of an apparatus for controlling a game progress provided by an embodiment of the present disclosure. As shown in FIG. 11, the apparatus 1100 for controlling the game progress includes:
a scene display module 1110, configured to display; in the action stage, at least part of a first virtual scene of the action stage and a first virtual object located in the first virtual scene in the graphical user interface:
a skill determination module 1120, configured to obtain a skill configuration parameter of the first virtual object to determine an additional skill, newly added on a basis of a character default skill, of the first virtual object, and the default skill is a skill assigned according to an identity attribute of the first virtual object:
a skill unlocking module 1130, configured to, when determining that a completion progress of a virtual task in the game stage reaches a progress threshold, control the first virtual object to unlock the additional skill, and provide an additional skill control that is configured to trigger the additional skill on a basis of providing a default skill control in the graphical user interface that is configured to trigger the default skill: and
a scene switching module 1140, configured to control the graphical user interface to display a second virtual scene corresponding to the discussion stage in response to a preset trigger event, the second virtual scene includes at least one of: a second virtual object, a character icon of the second virtual object, the first virtual object, and a character icon of the first virtual object, and the discussion stage is configured to determine a game state of at least one second virtual object or the first virtual object according to a result of the discussion stage.

Further, as shown in FIG. 12, the apparatus 1100 for controlling the game progress further includes a gambling skill release module 1150. The gambling skill release module 1150 is configured to:
after the identity gambling skill is unlocked, in response to an identity gambling skill control being triggered, control the first virtual object to perform identity gambling with the second virtual object; and
when the second virtual scene corresponding to the discussion stage is displayed, display information related to an identity gambling result on the first virtual object or the character icon of the first virtual object included in the second virtual scene, or, display the information related to the identity gambling result on the second virtual object or the character icon of the second virtual object included in the second virtual scene.

Further, as shown in FIG. 12, the apparatus 1100 for controlling the game progress further includes a verification skill release module 1160. The verification skill release module 1160 is configured to:
after the identity verification skill is unlocked, in response to an identity verification skill control being triggered, provide identity information of the second virtual object to the first virtual object.

Further, as shown in FIG. 12, the apparatus 1100 for controlling the game progress further includes a guidance skill release module 1170. The guidance skill release module 1170 is configured to:
after the guidance skill is unlocked, in response to a guidance skill control being triggered, obtain position information of the virtual object in the target state within a second distance threshold range from the first virtual object;
display, according to the position information, an indication identifier corresponding to the position information in the graphical user interface to indicate an orientation of the virtual object in the target state in the first virtual scene; and
in response to a movement instruction, control the first virtual object to move.

Further, as shown in FIG. 12, the apparatus 1100 for controlling the game progress further includes a doubling skill release module 1180. The doubling skill release module 1180 is configured to:
after the task doubling skill is unlocked, in response to a task doubling skill control being triggered, double, when a virtual task corresponding to the first virtual object is completed by the first virtual object, a reward of the virtual task according to a preset ratio.

Further, the virtual task includes tasks completed by all virtual objects with a first character attribute in the game stage;
the completion progress of the virtual task in the game stage indicates a progress of the virtual task being jointly completed by the virtual objects with the first character attribute in the game stage; and the first virtual object is a virtual object with the first character attribute.

Further, the additional skill includes at least one of: an identity gambling skill, an identity verification skill, a guidance skill, and a task doubling skill.

Further, the verification skill release module 1160 is further configured to:
display the identity information of the second virtual object at a preset position of the second virtual object in the first virtual scene of the action stage and/or the second virtual scene of the discussion stage displayed in the graphical user interface.

Further, when the scene switching module 1140 is configured to control the graphical user interface to display the second virtual scene corresponding to the discussion stage in response to the preset trigger event, the scene switching module 1140 is configured to:
in response to a distance between the first virtual object and a virtual object in a target state being less than a first distance threshold, control the graphical user interface to display the second virtual scene corresponding to the discussion stage.

Further, the completion progress of the virtual task is displayed through a first progress prompt control provided in the graphical user interface; and
the first progress prompt control is further displayed with at least one unlocking identifier configured to prompt that a corresponding additional skill is unlockable at a preset progress.

Further, a second progress prompt control corresponding to the additional skill is further provided in the graphical user interface, and the second progress prompt control is configured to display a progress that the additional skill is unlocked.

In the apparatus for controlling the game progress provided by embodiments of the present disclosure, the first virtual scene of the action stage and the first virtual object are displayed in the graphical user interface, and the additional skill, newly added on the basis of the default skill, of the first virtual object is determined according to the skill configuration parameter of the first virtual object. When it is determined that the virtual task completion progress in the game stage reaches the progress threshold, the first virtual object is controlled to unlock the additional skill, and the additional skill control that triggers the additional skill is displayed in the graphical user interface at the same time. In response to the preset trigger event, the graphical user interface is controlled to be switched to the second virtual scene of the discussion stage, and to simultaneously display game states of the first virtual object and each second virtual object. In this way, the game progress may be accelerated, thereby reducing the consumption of the power and the data traffic of the terminal.

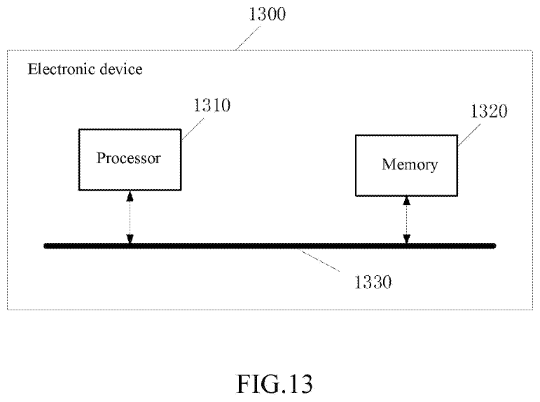

Reference is made to FIG. 13, which is a schematic structural diagram of an electronic device provided by an embodiment of the present disclosure. As shown in FIG. 13, the electronic device 1300 includes a processor 1310, a memory 1320 and a bus 1330.

The memory 1320 stores machine-readable instructions executable by the processor 1310. When the electronic device 1300 is running, the processor 1310 is in communication with the memory 1320 through the bus 1330. The machine-readable instructions, when executed by the processor 1310, may execute steps of the method for controlling the game progress in the method embodiment shown in FIG. 1 as described above. For specific implementations, reference may be made to the method embodiments, which will not be described again here.

Embodiments of the present disclosure further provide a computer-readable storage medium having a computer program stored thereon, which, when run by a processor, may execute steps of the method for controlling the game progress in the method embodiment shown in FIG. 1 as described above. For specific implementations, reference may be made to the method embodiments, which will not be described again here.

Those skilled in the art can clearly understand that for the convenience and simplicity of description, for specific working processes of the systems, apparatuses and units described above, reference may be made to corresponding processes in the foregoing method embodiments, which will not be described again here.

It should be understood in the several embodiments provided in the present disclosure that the systems, apparatuses and methods disclosed, may be implemented in other ways. For example, the device embodiments described above are merely schematic. The division of the units described is only a logical functional division, and in the actual implementation, there may be other ways of division, such as multiple units or components may be combined or may be integrated into another system, or some features may be ignored, or not implemented. On the other hand, the coupling or direct coupling or communication connection between each other shown or discussed may be a connection through some communication interface, and the indirect coupling or communication connection of devices or units, may be electrical, mechanical or other forms.

The units illustrated as separated components may or may not be physically separated, and the components shown as units may or may not be physical units, i.e., they may be located in a single place, or they may be distributed to a plurality of network units. Some or all of these units may be selected to fulfill the purpose of the solution of embodiments according to actual requirements.

In addition, the respective functional units in various embodiments of the present disclosure may be integrated in a single processing unit, or each unit may physically exist separately, or two or more units may be integrated in a single unit.

When the functions are implemented in a form of a software functional unit and sold or used as an independent product, the functions may be stored in a non-volatile computer-readable storage medium that is executable by a processor. Based on such an understanding, the technical solutions of the present disclosure essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of the present disclosure. The foregoing storage medium includes various media that can store program codes, such as a USB flash drive, a removable hard disk, a read-only memory (ROM), a random access memory (RAM), a magnetic disk, and an optical disc.

Finally, it should be noted that the foregoing embodiments are merely specific implementations of the present disclosure, and are intended for describing the technical solutions in the present disclosure but not for limiting the present disclosure. The protection scope of the present disclosure is not limited thereto. Although the present disclosure is described in detail with reference to the foregoing embodiments, persons of ordinary skill in the art should understand that they may still make modifications to the technical solutions described in the foregoing embodiments, or readily figure out variations, or make equivalent replacements to some technical features thereof, within the technical scope disclosed in the present disclosure. However, these modifications, variations, or replacements do not make the essence of the corresponding technical solutions depart from the spirit and scope of the technical solutions in embodiments of the present disclosure, and therefore shall fall within the protection scope of the present disclosure. Therefore, the protection scope of the present disclosure shall be subject to the protection scope of the appended claims.

1. A method for controlling a game progress, wherein a graphical user interface is provided by a terminal device, the graphical user interface comprises a virtual scene of a current game stage, and the game stage comprises an action stage and a discussion stage, and wherein the method comprises:
displaying, in the action stage, at least part of a first virtual scene of the action stage and a first virtual object located in the first virtual scene in the graphical user interface;
obtaining a skill configuration parameter of the first virtual object to determine an additional skill, newly added on a basis of a default skill, of the first virtual object, wherein the default skill is a skill assigned according to an identity attribute of the first virtual object;
when determining that a completion progress of a virtual task in the game stage reaches a progress threshold, controlling the first virtual object to unlock the additional skill, and providing an additional skill control that is configured to trigger the additional skill on a basis of providing a default skill control in the graphical user interface that is configured to trigger the default skill; and
controlling the graphical user interface to display a second virtual scene corresponding to the discussion stage in response to a preset trigger event, wherein the second virtual scene comprises at least one of: a second virtual object, a character icon of the second virtual object, the first virtual object, and a character icon of the first virtual object, and wherein the discussion stage is configured to determine a game state of the second virtual object or the first virtual object according to a result of the discussion stage.

2. The method according to claim 1, wherein the virtual task comprises tasks completed by all virtual objects with a first character attribute in the game stage; and
the completion progress of the virtual task in the game stage indicates a progress of the virtual task being jointly completed by the virtual objects with the first character attribute in the game stage, and the first virtual object is a virtual object with the first character attribute.

3. The method according to claim 1, wherein the additional skill comprises at least one of: an identity gambling skill, an identity verification skill, a guidance skill, and a task doubling skill.

4. The method according to claim 3, wherein in a case that the additional skill comprises the identity gambling skill, the method further comprises:
in a case that the identity gambling skill is unlocked, in response to an identity gambling skill control being triggered, controlling the first virtual object to perform identity gambling with the second virtual object; and
when the second virtual scene corresponding to the discussion stage is displayed, displaying information related to an identity gambling result on the first virtual object or the character icon of the first virtual object comprised in the second virtual scene, or, displaying the information related to the identity gambling result on the second virtual object or the character icon of the second virtual object comprised in the second virtual scene.

5. The method according to claim 3, wherein in a case that the additional skill comprises the identity verification skill, the method further comprises:
in a case that the identity verification skill is unlocked, in response to an identity verification skill control being triggered, providing identity information of the second virtual object to the first virtual object.

6. The method according to claim 5, wherein after the providing the identity information of the second virtual object to the first virtual object, the method further comprises:
displaying the identity information of the second virtual object at a preset position of the second virtual object.

7. The method according to claim 3, wherein the controlling the graphical user interface to display the second virtual scene corresponding to the discussion stage in response to the preset trigger event comprises:
in response to a distance between the first virtual object and a virtual object in a target state being less than a first distance threshold, controlling the graphical user interface to display the second virtual scene corresponding to the discussion stage.

8. The method according to claim 7, wherein in a case that the additional skill comprises the guidance skill, the method further comprises:
in a case that the guidance skill is unlocked, in response to a guidance skill control being triggered, obtaining position information of the virtual object in the target state within a second distance threshold range from the first virtual object;
displaying, according to the position information, an indication identifier corresponding to the position information in the graphical user interface to indicate an orientation of the virtual object in the target state in the first virtual scene; and
in response to a movement instruction, controlling the first virtual object to move.

9. The method according to claim 3, wherein in a case that the additional skill comprises the task doubling skill, the method further comprises:
in a case that the task doubling skill is unlocked, in response to a task doubling skill control being triggered, doubling, when a virtual task corresponding to the first virtual object is completed by the first virtual object, a reward of the virtual task according to a preset ratio.

10. The method according to claim 1, wherein the completion progress of the virtual task is displayed through a first progress prompt control provided in the graphical user interface; and
the first progress prompt control is further displayed with at least one unlocking identifier configured to prompt that a corresponding additional skill is unlockable at a preset progress.

11. The method according to claim 1, wherein a second progress prompt control corresponding to the additional skill is further provided in the graphical user interface, and the second progress prompt control is configured to display a progress that the additional skill is unlocked.

12. (canceled)

13. An electronic device, comprising: a processor, a storage medium and a bus, wherein a graphical user interface is provided by the electronic device, the graphical user interface comprises a virtual scene of a current game stage, and the game stage comprises an action stage and a discussion stage, and wherein machine-readable instructions executable by the processor are stored in the storage medium, and when the electronic device is running, the processor is in communication with the storage medium through the bus, and the processor is configured to execute the machine-readable instructions to execute;
displaying, in the action stage, at least part of a first virtual scene of the action stage and a first virtual object located in the first virtual scene in the graphical user interface;
obtaining a skill configuration parameter of the first virtual object to determine an additional skill, newly added on a basis of a default skill, of the first virtual object, wherein the default skill is a skill assigned according to an identity attribute of the first virtual object;
when determining that a completion progress of a virtual task in the game stage reaches a progress threshold, controlling the first virtual object to unlock the additional skill, and providing an additional skill control that is configured to trigger the additional skill on a basis of providing a default skill control in the graphical user interface that is configured to trigger the default skill; and
controlling the graphical user interface to display a second virtual scene corresponding to the discussion stage in response to a preset trigger event, wherein the second virtual scene comprises at least one of: a second virtual object, a character icon of the second virtual object, the first virtual object, and a character icon of the first virtual object, and wherein the discussion stage is configured to determine a game state of the second virtual object or the first virtual object according to a result of the discussion stage.

14. A non-transitory computer-readable storage medium having a computer program stored thereon, wherein a graphical user interface is provided by the electronic device, the graphical user interface comprises a virtual scene of a current game stage, and the game stage comprises an action stage and a discussion stage, and wherein the computer program, when run by a processor, executes the following operations:
displaying, in the action stage, at least part of a first virtual scene of the action stage and a first virtual object located in the first virtual scene in the graphical user interface;
obtaining a skill configuration parameter of the first virtual object to determine an additional skill, newly added on a basis of a default skill, of the first virtual object, wherein the default skill is a skill assigned according to an identity attribute of the first virtual object;
when determining that a completion progress of a virtual task in the game stage reaches a progress threshold, controlling the first virtual object to unlock the additional skill, and providing an additional skill control that is configured to trigger the additional skill on a basis of providing a default skill control in the graphical user interface that is configured to trigger the default skill; and
controlling the graphical user interface to display a second virtual scene corresponding to the discussion stage in response to a preset trigger event, wherein the second virtual scene comprises at least one of: a second virtual object, a character icon of the second virtual object, the first virtual object, and a character icon of the first virtual object, and wherein the discussion stage is configured to determine a game state of the second virtual object or the first virtual object according to a result of the discussion stage.

15. The method according to claim 1, wherein the first virtual scene is switched according to movement of the first virtual object.

16. The method according to claim 1, wherein the first virtual scene comprises a scene thumbnail corresponding to the first virtual scene.

17. The method according to claim 1, wherein the additional skill comprises an active skill and a passive skill.

18. The method according to claim 17, wherein the additional skill refers to an additional skill that the first virtual object has an ability to actively select an object to which the additional skill is applied.

19. The method according to claim 17, wherein the passive skill refers to an additional skill that the first virtual object does not have the ability to actively select the object to which the additional skill is applied.

20. The method according to claim 10, wherein the first progress prompt control is in a form of progress bar.
